(19) United States
(12) Patent Application Publication
(10) Pub. No.: US 2026/0233445 A1
(43) Pub. Date: Aug. 13, 2026

(54) MANUFACTURING METHOD OF TANK

(71) Applicant: TOYOTA JIDOSHA KABUSHIKI KAISHA, Toyota-shi (JP)

(72) Inventor: Ken HATTA, Toyota-shi (JP)

(73) Assignee: TOYOTA JIDOSHA KABUSHIKI KAISHA, Toyota-shi (JP)

(21) Appl. No.: 19/426,599

(22) Filed: Dec. 19, 2025

(30) Foreign Application Priority Data
Feb. 7, 2025 (JP) 2025-019296

(51) Int. Cl. B29C 45/16; B29C 45/14; B29C 70/46; B29C 70/48; B29K 105/00; B29K 105/08; B29K 307/04; B29L 31/00

(52) U.S. Cl. CPC B29C 45/1635; B29C 45/14622; B29C 45/1671; B29C 70/462; B29C 70/48; B29K 2105/0032; B29K 2105/0872; B29K 2307/04; B29L 2031/7156

(57) ABSTRACT

A manufacturing method includes first disposing, of disposing a semi-finished product of a tank before being impregnated with a resin in a cavity of a mold, in which the mold includes a runner connected to the cavity, an extrusion hole branching from the runner, and an extruder slidably disposed inside the extrusion hole, first injecting, of injecting the resin into the cavity through the runner, following the first disposing, second disposing, of disposing a colorant in the extrusion hole following the first injecting, and second injecting, of injecting the resin into the cavity of the mold through the runner while pushing the extruder toward the runner, following the second disposing.

### CROSS-REFERENCE TO RELATED APPLICATION

This application claims priority to Japanese Patent Application No. 2025-019296 filed on Feb. 7, 2025. The disclosure of the above-identified application, including the specification, drawings, and claims, is incorporated by reference herein in its entirety.

### BACKGROUND

### 1. Technical Field

The technology disclosed in the present specification relates to a method for manufacturing a tank.

### 2. Description of Related Art

Japanese Unexamined Patent Application Publication No. 2021-167653 (JP 2021-167653 A) discloses a manufacturing method of a tank, in which a carbon fiber layer is impregnated with resin. The manufacturing method includes a step of disposing a semi-finished product of a tank before being impregnated with resin in a cavity of a mold, and then a step of injecting resin into the cavity.

### SUMMARY

When voids, welds, or the like occur on the surface of the resin-impregnated carbon fiber layer, the quality of the external appearance of the finished tank will be diminished. Also, while a painting step is expected to be added to paint the surface of the resin-impregnated carbon fiber layer, adding the painting step will increase manufacturing costs.

The present specification provides technology for suppressing both diminished quality of external appearance and increase in manufacturing costs.

Disclosed in the present specification is a manufacturing method of a tank in which a carbon fiber layer is impregnated with a resin. The manufacturing method includes first disposing, of disposing a semi-finished product of the tank before being impregnated with the resin in a cavity of a mold, in which the mold includes a runner connected to the cavity, an extrusion hole branching from the runner, and an extruder slidably disposed inside the extrusion hole, first injecting, of injecting the resin into the cavity through the runner, following the first disposing, second disposing, of disposing a colorant in the extrusion hole following the first injecting, and second injecting, of injecting the resin into the cavity of the mold through the runner while pushing the extruder toward the runner, following the second disposing.

According to the above configuration, injecting the resin in the two stages of the first injecting and the second injecting enables voids, welds, and so forth to be suppressed from occurring on the surface of the carbon fiber layer. Also, in the second injecting that is performed the second time, the colorant in the extrusion holes is mixed with the resin, thereby coloring the surface of the carbon fiber layer. This does away with the need for a step for painting the surface of the carbon fiber layer. Thus, suppressing diminished quality of external appearance and suppressing increase in manufacturing costs can both be realized.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a configuration diagram of a manufacturing device of a tank;

FIG. 2 is a top view of a lower mold;

FIG. 3 is a configuration diagram of the manufacturing device in a lifted state;

FIG. 4 is a diagram illustrating a manufacturing method of the tank;

FIG. 5 is a diagram illustrating the manufacturing method of the tank; and

FIG. 6 is a graph showing transition of pressure in a semi-finished product of the tank and in a cavity.

### DETAILED DESCRIPTION OF EMBODIMENTS

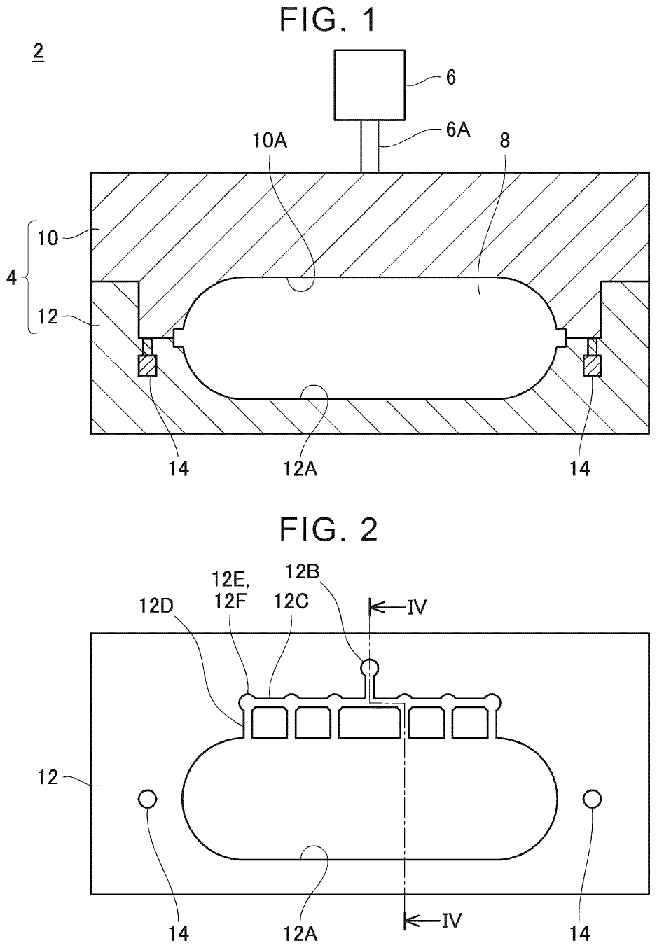

### Configuration of Manufacturing Device 2: FIGS. 1 to 3

A manufacturing device 2 is a device for manufacturing tanks. The tank is a high-pressure tank for a fuel cell electric vehicle, for example. The tank includes a liner that defines an interior space of the tank, and a carbon fiber layer formed on an outer face of the liner. The carbon fiber layer is impregnated with resin by the manufacturing device 2.

The manufacturing device 2 includes a mold 4 in which a semi-finished product 8 of the tank is disposed before being impregnated with resin, and an injection machine 6 that injects resin into the mold 4. The mold 4 is made up of a pair of molds 10 and 12 that clamps the semi-finished product 8. Specifically, the mold 4 includes an upper mold 10 and a lower mold 12. A cavity 10A, conforming to an outer shape of an upper side of the semi-finished product 8, is formed in a lower face of the upper mold 10. A cavity 12A, conforming to an outer shape of a lower side of the semi-finished product 8, is formed in an upper face of the lower mold 12.

As illustrated in FIG. 2, a gate 12B, a main runner 12C, and a plurality of sub-runners 12D, are formed in the upper face of the lower mold 12. Note that in FIG. 2, one of the sub-runners 12D is labeled by a reference numeral, and the remaining sub-runners are not labeled by reference numerals.

One end of the gate 12B is connected to a channel 6A that extends from the injection machine 6 and passes through the upper mold 10. The other end of the gate 12B is connected to the main runner 12C that extends along a longitudinal direction of the tank. The sub-runners 12D branch off from the main runner 12C. The sub-runners 12D are connected to the cavity 12A.

The resin injected from the injection machine 6 passes over the channel 6A and the gate 12B, and flows into the main runner 12C. The resin that flows into the main runner 12C flows into each of the sub-runners 12D, and then flows from each of the sub-runners 12D into the cavity 12A.

Extrusion holes 12E are formed at connection points of the main runner 12C and each of the sub-runners 12D. The extrusion holes 12E branch off from the sub-runners 12D along a depth direction of the cavity 12A. As illustrated in FIG. 2, the lower mold 12 has as many extrusion holes 12E formed therein as the number as the sub-runners 12D. Note that the number of the extrusion holes 12E illustrated in FIG. 2 is merely an example. The lower mold 12 may have fewer of the extrusion holes 12E than the number of the sub-runners 12D formed therein, or may have more of the extrusion holes 12E than the number of the sub-runners 12D formed therein.

An extruder 12F is slidably disposed inside each of the extrusion holes 12E. The extrusion hole 12E and the extruder 12F make up a piston. By pushing the extruder 12F toward the sub-runner 12D, pressure can be applied to the resin flowing through the sub-runner 12D. Note that in FIG. 2, one of a plurality of the extrusion holes 12E and one of a plurality of the extruders 12F are labeled by reference numerals, and the rest are not labeled by reference numerals.

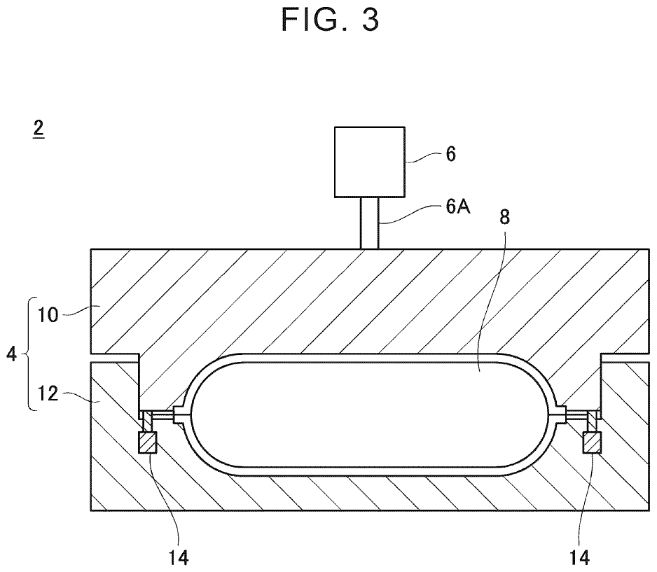

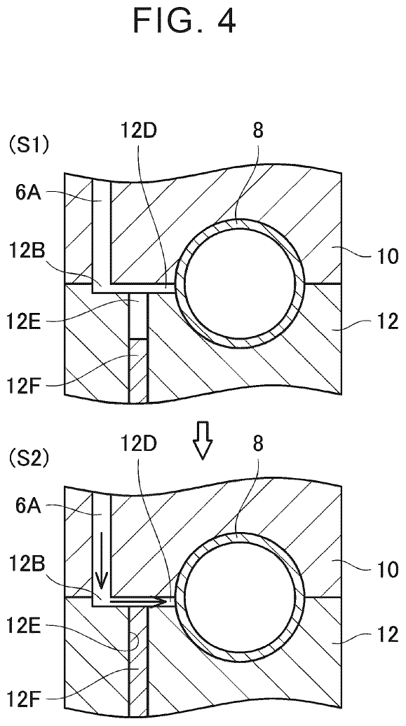

The lower mold 12 is also provided with lift mechanisms 14 that lift the semi-finished product 8 and the upper mold 10 from the lower mold 12. FIG. 3 illustrates a lifted state in which the lift mechanisms 14 have lifted the semi-finished product 8 and the upper mold 10. The lift mechanism 14 can maintain the state of the mold 4 in a lifted state. The lift mechanism 14 forms a predetermined gap between the semi-finished product 8 and the cavity 10A, and between the semi-finished product 8 and the inner face of the cavity 12A. The width of the predetermined gap is, for example, several mm.

### Manufacturing Method of Tank: FIGS. 4 to 6

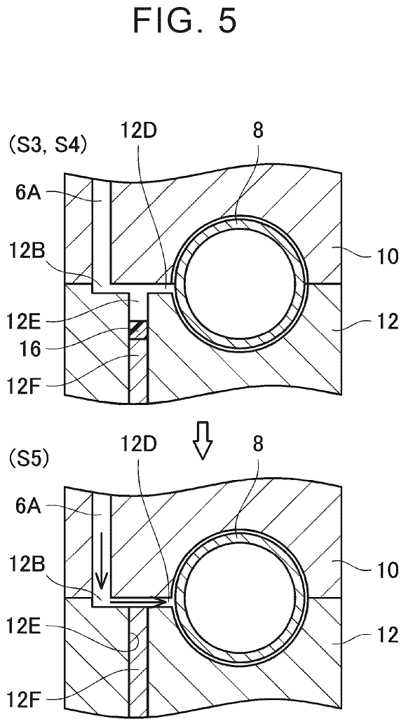

A manufacturing method for manufacturing the tank in which the carbon fiber layer is impregnated with resin will be described, with reference to FIGS. 4 to 6. The manufacturing method is realized by controlling the manufacturing device 2. Note that FIGS. 4 and 5 are cross-sectional views of the manufacturing device 2 taken along line IV-IV in FIG. 2.

FIG. 4 illustrates a first disposing step S1 and a first injecting step S2. In the first disposing step S1, the mold 4 is opened, and the semi-finished product 8 is disposed in the cavity 12A of the lower mold 12. Mold clamping is then performed to press the upper mold 10 against the lower mold 12. Thereafter, degassing is carried out to bring the cavities 10A and 12A of the mold 4 into a state close to a vacuum. Note that in each of the drawings, a device that performs degassing is omitted from illustration. Note that in the first disposing step S1, the extruder 12F is situated at a start end position farthest from the sub-runners 12D.

After the first disposing step S1, the first injecting step S2 is performed. In the first injecting step S2, the injection machine 6 starts injecting the resin into the mold 4. The resin is injected into the cavities 10A and 12A through the channel 6A, the gate 12B, the main runner 12C, and the sub-runners 12D.

In the first injecting step S2, the extruders 12F are pushed from the start end position toward the sub-runner 12D, and move to a terminal end position closest to the sub-runner 12D. This applies additional pressure to the resin being injected into the cavities 10A and 12A.

In the first injecting step S2, the carbon fiber layer of the semi-finished product 8 in the cavities 10A and 12A is impregnated by the resin. Once a predetermined amount of resin has been injected, the injection machine 6 stops injecting the resin.

In the first injecting step S2, the pressure in the cavities 10A and 12A is measured. A pressure sensor for measuring the pressure in the cavities 10A and 12A is disposed, for example, on the inner face of the cavity 10A. Note that in a modification, the pressure sensor may be disposed in a space communicating with the cavities 10A and 12B, in the extrusion hole 12E, for example.

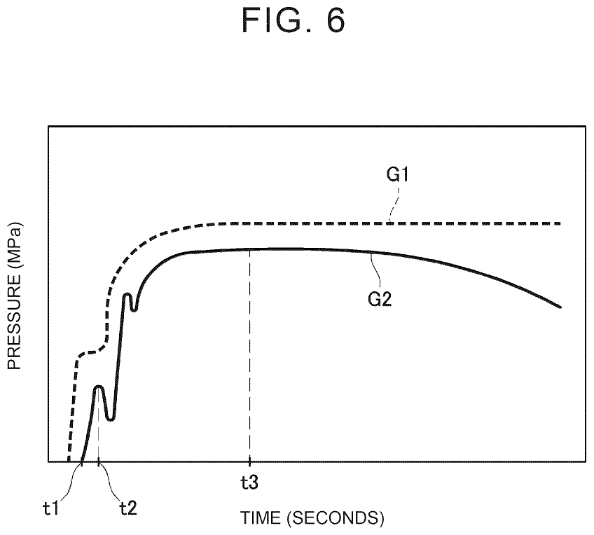

FIG. 6 is a graph G1 showing transition in pressure inside the semi-finished product 8, and a graph G2 showing transition in pressure inside the cavities 10A and 12B. In the graphs G1 and G2, the horizontal axis represents time and the vertical axis represents pressure.

Timing t1 indicates a timing at which injection begins in the first injecting step S2. As indicated by the graphs G1 and G2, as the resin starts to be injected, both the pressure inside the semi-finished product 8 and the pressure inside the cavities 10A and 12B rise.

Timing t2 indicates a timing at which the injection in the first injecting step S2 is stopped. As indicated by graph G2, when the injection of the resin stops, the pressure in the cavities 10A and 12B decreases, but then increases again. Thereafter, the pressure in the cavities 10A and 12B reaches a peak value and then decreases from the peak value at a timing t3. The timing t3 indicates a timing when the resin starts to cure. The timing t3 is detected using transition of the measurement value of the pressure sensor.

In the present embodiment, the mold 4 is opened when the pressure in the cavities 10A and 12B drops by a predetermined value from the peak value. When the mold 4 is opened, the resin inside the gate 12B, the main runner 12C, and the sub-runners 12D is removed. A second disposing step S3 in FIG. 5 is then carried out. In the second disposing step S3, the extruders 12F are returned from the terminal end position to the start end position. A colorant 16 is then disposed in the extrusion holes 12E.

After the second disposing step S3, a separating step S4 is performed. In the separating step S4, the mold 4 is closed, and the lift mechanisms 14 maintain the mold 4 in the lifted state. Thus, a predetermined gap is formed between the semi-finished product 8 and the inner faces of the cavities 10A and 12A. Also, degassing is performed as well in the separating step S4.

After the separating step S4, a second injecting step S5 is performed. In the second injecting step, the injection machine 6 starts injecting the resin into the mold 4 again while pushing out the extruders 12F toward the sub-runners 12D. When passing through the sub-runners 12D, the resin is mixed with the colorant 16 extruded by the extruders 12F. The resin mixed with colorant 16 is injected into the cavities 10A and 12A. The resin mixed with the colorant 16 covers the outer surface of the carbon fiber layer impregnated with the resin in the first injecting step S2, through the predetermined gap formed in the separating step S4.

### Effects of Present Embodiment

According to the configuration of the present embodiment, injecting the resin in the two stages of the first injecting step S2 and the second injecting step S5 enables voids, welds, and so forth to be suppressed from occurring on the surface of the carbon fiber layer. Also, in the second injecting step S5 that is performed the second time, the colorant 16 in the extrusion holes 12E is mixed with the resin, thereby coloring the surface of the carbon fiber layer. This does away with the need for a step for painting the surface of the carbon fiber layer. Thus, suppressing diminished quality of external appearance and suppressing increase in manufacturing costs can both be realized.

### Correlative Relations

The semi-finished product 8 is an example of “semi-finished product”. The mold 4, and the molds 10 and 12, are examples of “mold” and “pair of molds”, respectively. The cavities 10A and 12A are examples of “cavity”. The main runner 12C and the sub-runners 12D are examples of “runner”. The extrusion holes 12E and the extruders 12F are examples of “extrusion holes” and “extruders”, respectively. The colorant 16 is an example of “colorant”.

Points to note regarding the technology set forth in the examples will be described below. The separating step S4 does not have to be performed. Also, in the first injecting step S2, the extruders 12F do not need to be moved.

Also, the timing for opening the mold after the first injecting step S2 may be a timing when a condition other than the condition based on the transition of the measurement value of the pressure sensor is satisfied. This timing may be, for example, a timing when a predetermined amount of time has elapsed since the start of the first injecting step S2.

What is claimed is:

1. A manufacturing method of a tank in which a carbon fiber layer is impregnated with a resin, the manufacturing method comprising:
first disposing, of disposing a semi-finished product of the tank before being impregnated with the resin in a cavity of a mold, in which the mold includes a runner connected to the cavity, an extrusion hole branching from the runner, and an extruder slidably disposed inside the extrusion hole;
first injecting, of injecting the resin into the cavity through the runner, following the first disposing;
second disposing, of disposing a colorant in the extrusion hole following the first injecting; and
second injecting, of injecting the resin into the cavity of the mold through the runner while pushing the extruder toward the runner, following the second disposing.

2. The manufacturing method according to claim 1, wherein
the mold includes a pair of molds that clamp the semi-finished product,
the manufacturing method further comprising separating, of separating the molds from each other such that a predetermined gap is created between the semi-finished product and an inner face of the cavity, following the first injecting.

3. The manufacturing method according to claim 2, wherein, in the separating, the molds are separated from each other when a transition in pressure within the cavity satisfies a predetermined condition.

4. The manufacturing method according to claim 3, wherein the predetermined condition is that the pressure drops from a peak value by a predetermined value, following reaching the peak value.

5. The manufacturing method according to claim 1, wherein
in the first injecting, the resin is injected into the cavity through the runner while the extruder is pushed toward the runner, and
in the second disposing, the colorant is disposed in the extrusion hole, following the extruder being separated from the runner.
